(19) United States
(12) Patent Application Publication
(10) Pub. No.: US 2005/0168980 A1
(43) Pub. Date: Aug. 4, 2005

(54) Vein locator

(76) Inventors: Paul E. Dryden, McCordsville, IN (US); Kenneth A. Haselby, Zionsville, IN (US)

Correspondence Address: SWANSON & BRATSCHUN L.L.C., 1745 SHEA CENTER DRIVE, SUITE 330, HIGHLANDS RANCH, CO, 80129, US

(21) Appl. No.: 11/043,300

(22) Filed: Jan. 25, 2005

Related U.S. Application Data
(60) Provisional application No. 60/540,585, filed on Jan. 30, 2004.

(51) Int. Cl. F21V 9/08

(52) U.S. Cl. 362/230

(57) ABSTRACT

A trans-illuminating vein locator including a housing which has a base and a cap. In addition, a lens is operatively associated with the cap such that the cap and lens form a work surface which may be supported by the base. The work surface is configured to support a portion of a patient's body for examination. The trans-illuminating vein locator also includes one or more LEDs operatively disposed within the housing and configured to emit light through the lens to trans-illuminate a portion of a patient's body. Preferably, the light emitted by the one or more LEDs has a predominant wavelength of substantially between 600 nm and 640 nm, and is projected at a dispersion angle of 30 degrees or less.

### RELATED APPLICATION DATA

This application claims benefit of U.S. Provisional Patent Application Ser. No. 60/540,585, entitled VEIN LOCATOR, filed Jan. 30, 2004, which application is incorporated herein by reference in its entirety.

### TECHNICAL FIELD

The present invention is directed toward a vein locator, and more particularly toward a trans-illumination vein locator.

### BACKGROUND ART

Locating veins for easy intravenous injections can prove troublesome for clinicians. Particularly problematic is locating veins in neonates, pediatric patients, older adults, obese patients, and patients with low blood pressure.

To assist in finding a vein to be accessed, clinicians have traditionally used a number of techniques. These include use of a tourniquet, palpitation, rubbing the area, asking the patient to make a fist, and use of a light, among others. Known in the prior art are a number of illuminated devices for assisting in the location of veins. These illuminated vein locators generally use one of two primary light sources: first, high intensity lights, e.g., halogen, which are very high intensity and generate intense heat which can burn the patient. As a result, such devices require a significant energy input, therefore requiring either a large battery or access to an AC electrical line. Second, a light source that uses LEDs which are both cooler and require lower energy inputs, but which may lack sufficient intensity to function effectively.

Illustrative of illuminated vein locators using high intensity lights is the Veinlite product sold by Veinlite of Sugarland, Tex. The Veinlite device uses a ring illuminator for side trans-illumination. The light source is a 50 watt halogen bulb which is located remote from the ring illuminator. A high quality fiber optic cable joins the ring illuminator to the high intensity halogen light source. The Veinlite device is described in greater detail in U.S. Pat. No. 5,146,923. While the device can do a satisfactory job illuminating target veins, the requirement of a high energy halogen bulb makes it difficult to transport the Veinlite and prevents the Veinlite from being pocket sized for ready access by mobile clinicians. In addition, the high energy halogen bulb is a potential danger for users because of the high temperature at which it operates.

Olympic Medical of Snoqualmie, Wash., distributes an Olympic Trans-Lite Vein Illuminator which utilizes a high intensity halogen bulb and allows for variable intensity light, including a red light for use with infants. While the Olympic Medical device is readily transportable, its high intensity halogen light source can quickly deplete batteries creating a potential inconvenience for clinicians. In addition, Olympic does not appear to teach use of a light wavelength which optimizes vein location.

Venoscope, LLC of Lafayette, La., produces the Venoscope II, which is a battery operated, high intensity LED trans-illuminator. The Venoscope II features a pair of arms each having a cluster of three equilaterally spaced LEDs. The Venoscope II device is primarily used as a surface illuminator, but is also taught as being suitable for trans-illumination through the tissue of neonates and pediatrics. While the use of the LEDs eliminates many of the problems of the Veinlite, Olympic Trans-Lite, and other devices using high energy halogen light sources, the Venoscope does not utilize an LED with a predominate wavelength suitable for illuminating target veins.

Another class of devices uses illumination and detectors for producing images of blood-ridge tissue on a monitor. Illustrative is Kimble, United States Patent Application Publication No. 2000/0018271 A1. However, the Kimble device is not readily transportable, and is thus incapable of widespread and convenient use.

The present invention is directed toward overcoming one or more of the problems discussed above.

### SUMMARY OF THE INVENTION

One aspect of the present invention is a trans-illuminating vein locator including a housing which has a base and a cap. In addition, a lens is operatively associated with the cap such that the cap and lens form a work surface which may be supported by the base. The work surface is configured to support a portion of a patient's body for examination. The trans-illuminating vein locator also includes an LED operatively disposed within the housing and configured to emit light through the lens to trans-illuminate a portion of a patient's body.

The housing and lens may define a substantially fluid-tight interior chamber. In addition, the trans-illuminating vein locator may include a power switch operatively associated with the enclosure further providing a substantially fluid-tight barrier between the switch and the interior chamber. The trans-illuminating vein locator may include a power source operatively disposed within the housing. The power source will typically be commonly available batteries. In addition, the trans-illuminating vein locator may also include an attachment clip operatively associated with the enclosure.

One aspect of the trans-illuminating vein locator includes one or more LED lamps which are configured to emit light having a wavelength substantially between 600 nm and 640 nm. In addition, the one or more LEDs may be configured to emit light at an angle of dispersion of substantially 30 degrees or less. Control of dispersed light may be accomplished in part by potting any LED in a substantially opaque material.

Another embodiment of the trans-illuminating vein locator includes a triangular LED lamp array operatively disposed within the housing and configured to emit light through the lens. An embodiment featuring an LED array also may utilize LEDs configured to emit light having a wavelength substantially between 600 nm and 640 nm. In addition, the LEDs are preferably configured to emit light at an angle of dispersion of substantially 30 degrees or less.

Another aspect of the present invention is a method of venous trans-illumination including providing a trans-illumination device having a work surface and base. The method further includes supporting a portion of a patient's body on the work surface and directing light from a lens associated with the work surface into the portion of the patient's body. The trans-illumination light may be emitted from one or more LED lamps operatively associated with the trans-illumination device. The one or more LEDs may be configured to emit light having a wavelength substantially between 600 nm and 640 nm, and the LEDs may be configured to emit light at an angle of dispersion of substantially 30 degrees or less.

### BRIEF DESCRIPTION OF THE DRAWINGS

FIG. 1 is a front perspective view of a trans-illumination vein locator in accordance with the present invention;

FIG. 2 is a rear perspective view of the trans-illumination vein locator of FIG. 1;

FIG. 3 is a front elevation view of the trans-illumination vein locator of FIG. 1;

FIG. 4 is a left side elevation view of the trans-illumination vein locator of FIG. 1;

FIG. 5 is a cross-section of the trans-illumination vein locator of FIG. 1 taken along line A-A of FIG. 3;

FIG. 6 is a cross-section of the trans-illumination vein locator of FIG. 1 taken along line B-B of FIG. 5;

FIG. 7 is a partially exploded perspective view of the trans-illumination vein locator of FIG. 1; and

FIG. 8 is an exploded view of the trans-illumination vein locator of FIG. 1.

### DETAILED DESCRIPTION OF THE PREFERRED EMBODIMENT

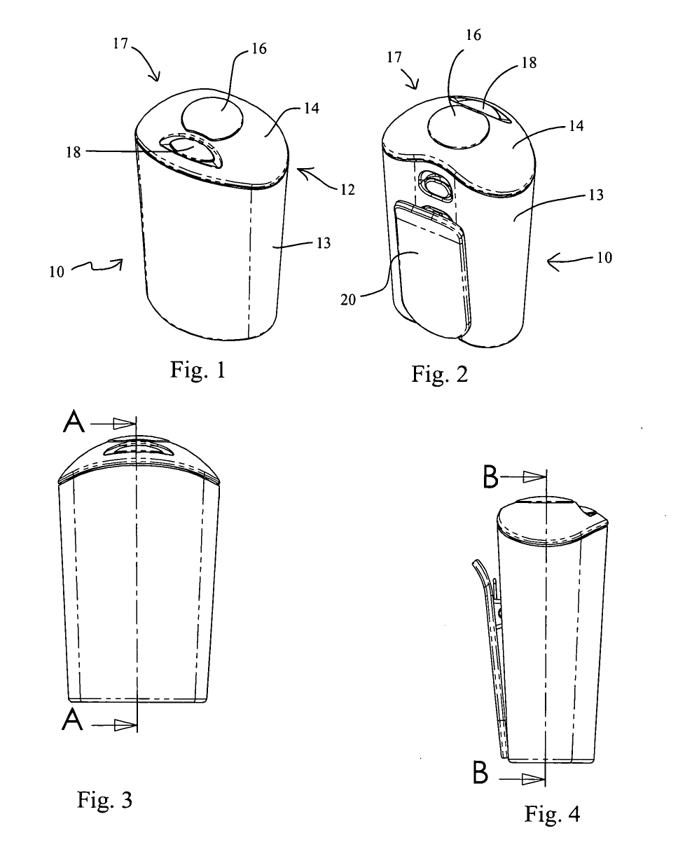

FIGS. 1-4 illustrate a novel external configuration of a preferred embodiment of a trans-illumination vein locator 10 in accordance with the present invention. Referring to FIG. 1, the trans-illumination vein locator 10 includes a housing 12 having a base 13 and a cap 14. A lens 16 made of a clear plastic, acrylic, or other light transmitting substance is fitted within the cap 14. Together, the cap 14 and lens 16 form a work surface 17 supported by the base 13. The work surface 17 is configured to support a portion of a patient's body for examination. The work surface 17 may be domed to comfortably support an appendage such as a finger or a small child's wrist. An on/off switch 18, which may be a membrane switch or any other switch configured to seal with the cap 14 and thus limit introduction of fluids to the interior of the housing 12, is also present in association with the housing 12. Similarly, the lens 16 and housing 12 engage in a sealed manner and define a substantially fluid-tight interior chamber 22.

Referring to FIG. 2, a removable clip assembly 20 is provided on the back of the housing 12 for fastening the trans-illumination vein locator 10 to the belt or a pocket of a clinician. FIGS. 3-4 provide various other views of the exterior of the trans-illumination vein locator 10 as described above in the brief description of the drawings.

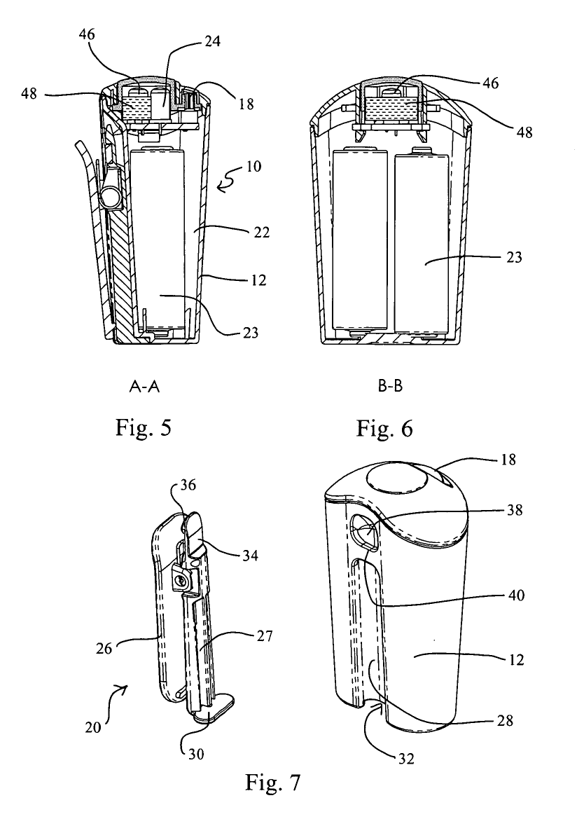

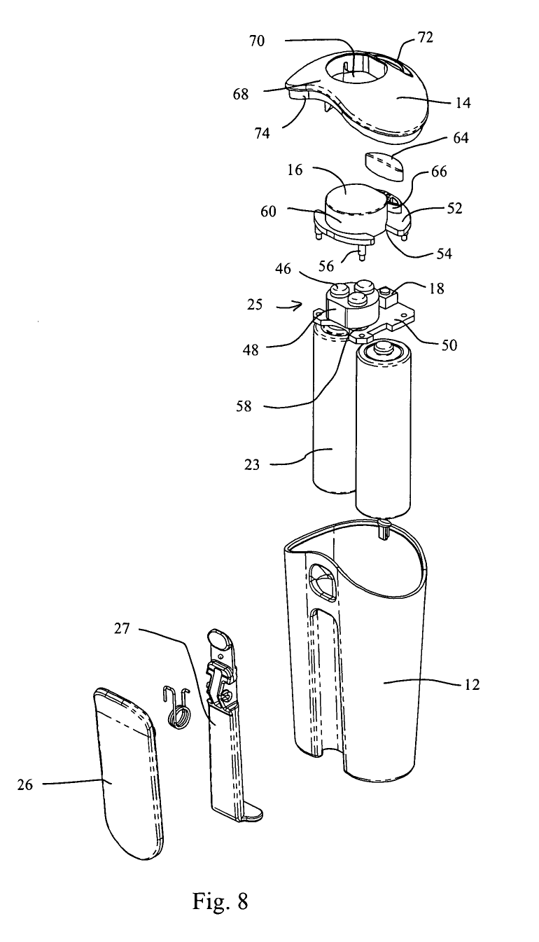

FIG. 5 is a cross section of the trans-illumination vein locator 10 taken along line A-A of FIG. 3. As seen in FIG. 5, the housing 12, lens 16, and switch 18 define a preferably fluid-tight chamber 22. Included within the chamber 22 is a power source, for example a pair of batteries 23, which preferably are AA-size batteries. Both batteries 23 can be seen in FIG. 6, which is a cross section of the trans-illumination vein locator 10 along line B-B of FIG. 4. The batteries 23 are part of an electric circuit including one or more light emitting diode (LED) lamps 24 which are preferably provided in an array 25 of three lamps 24 arranged in an equilateral triangle, as best seen in FIG. 8. The on/off switch 18 is also part of the electric circuit and controls the flow of current to the LED lamps 24. Although not shown, a rheostat or other control device could be provided in the circuit to vary the LED intensity.

FIG. 7 is an exploded view showing the clip assembly 20 disconnected from the back of the housing 12. In the preferred embodiment illustrated in FIG. 7, the clip assembly 20 includes a tongue 26 pivotably attached to a stem 27 which is axially received in an elongate slot 28 formed in the back of the housing 12. With the stem 27 received in the elongate slot 28, a foot 30 of the stem 27 is received in a cavity 32 in the bottom of the housing 12. A flexible wing 34 at the top of the stem 27 includes a detent 36 which extends into the orifice 38 in the back of the housing 12 to releasably lock the clip assembly 20 into the elongate slot 28. For clinicians preferring to use a lanyard instead of the clip assembly 20, the lanyard can be received in the orifice 28 and wrapped around the dividing wall 40 to secure the lanyard (not shown) to the housing 12.

The exploded view of FIG. 8 best illustrates the internal elements of the trans-illumination vein locator 10 of the present invention. Each of the LED lamps 24 preferably consist of an LED 46 potted or enclosed in a substantially opaque material such as a shell 48 which minimizes diffusion of light from the side of the LED 46. The shell 48 may be an opaque resin such as epoxy, an opaque elastomeric gasket, or other opaque material. In the preferred embodiment, a triangular array 25 of three equally spaced 5 mm LEDs is provided. As shown in FIG. 8, the array 25 may be formed within a single shell 48. Each LED is focused at a select angle to maximize the concentration of light at a select location within the tissue where a vein is to be located. A 15 degree angle of dispersion (or focus angle) has proven effective. In addition, a dispersion angle of 30 degrees is suitable for effective trans-illumination. Other angles of dispersion (or focus angles) may be acceptable as well. The relatively narrow focus angle is beneficial as more light is directed into the patient tissue for trans-illumination. Each of the LED lamps 24, singularly or in an array 25 as shown in FIG. 8, is secured to a plate 50 to which the on/off switch 18 is also attached. Preferably, the plate 50 is a printed circuit board with integrated contacts for the batteries 23. A lens assembly 52 includes a base 54 having a number of downwardly protruding legs 56 which are received in holes 58 in the plate 50 to secure the lens assembly 52 to the plate 50. A cylindrical extension 60 extends upward from the base 54 and is configured to receive therein the lamps 24 or array 25. A transparent lens 16 caps the cylindrical extension 60. The lens 16 can be configured to further focus the light emitted from the LEDs 46 as desired. Alternatively, the lens 16 could be a variable focusing lens that could be extended or retracted relative to the cylindrical extension to vary the focus of the LEDs 46.

A membrane switch cover 64 is preferably received in a oval extension 66 from the base 54 to seal the switch 18 within the interior of the housing 12. Alternatively, a suitable membrane switch could be used. The preferably opaque cap 14 has a circular hole 70 and oval hole 72 for receiving the lens 16 and the oval extension 66 covered by the cap 14. Making the cap 14 of an opaque material further minimizes loss of light from the LEDs 46 and allows for concentration of the light emitted from the LEDs 46 within the tissue being examined. When assembled, the plate 50, the base 54, and the cap 14 can be connected by adhesives, sonic welding, heat bonding, or any other suitable technique to both rigidly secure them and to seal the interior elements within the chamber 22. In this manner of construction, the unit would be disposable upon depletion of the batteries 23. Alternatively, the cap 14 could be provided with an appropriate elastometric seal around the flange 74 and engaging lips could be provided on the distal end of the flange 74 to allow the cap 14 to be removably attached to the open top of the housing 12.

The LEDs 46 are preferably configured to emit red light having a predominant wavelength of between 600 nm and 640 nm. In a highly preferred embodiment, the LEDs 46 are configured to emit red light having a predominant wavelength between 620 nm and 640 nm. Red light having a wavelength between 600 nm and 640 nm possesses three useful characteristics for effective trans-illumination. First, light in this wavelength range is absorbed by hemoglobin, therefore, veins under trans-illumination appear black. Secondly, light in this wavelength range is substantially transmitted by other tissue, thus patient tissue which is not venous appears pink or red. Thus, light in the specified wavelength range provides maximum contrast between veins and other tissue. Thirdly, light in the specified wavelength range is within the visible spectrum, thus allowing a technician to easily and directly view veins under trans-illumination.

In use, the on/off switch 18 is depressed to illuminate the LED lamps 24. Care should be taken to prevent looking directly into the bright beam of the LED lamps 24 to prevent discomfort to either the patient or the clinician. The portion of the patient's body to be examined for veins is then draped over the cap 14 with the light shining through the lens 16. The base 13 and work surface 17 are configured to support the portion of the patient's body being examined. The clinician can then identify light absorbing dark lines within the patient's tissue which will be the patient's veins. The particular configuration of the housing 12 including the work surface 17 illustrated herein is well suited to identifying veins in the hands and fingers of patients. However, the trans-illumination vein locator 10 is also suitable for finding veins in feet and other portions of a patient's anatomy thin enough to allow light to diffuse visibly through the tissue so as to allow the veins, which appear dark, to be viewed.

Use of the LEDs 46 as a light source minimizes the danger of burning patients with whom the device is used and will prevent injury to the eyes of a clinician or the patient if they inadvertently look directly into the light source. The lens 16 further shields the patient from any heat which is produced by the LEDs 46. In addition, LEDs 46 are available which emit in a relatively narrow spectral band, preferably with a predominant wavelength of 600 nm to 640 nm, and ideally 620 nm to 640 nm. As described above, light with this wavelength has been found to highlight veins with respect to the tissue.

A substantially fluid tight chamber 22 holding all internal components within the housing 12 limits the infusion of blood or other fluids to the interior of the housing 12 which could inhibit operation of the trans-illumination vein locator 10 and create a health hazard. The exterior components are also preferably selected of materials which can withstand common disinfectants. The clip 20 or lanyard options make the trans-illumination vein locator 10 of the present device convenient for clinicians to carry, thus facilitating widespread use of the trans-illumination vein locator 10. Finally, the components from which the trans-illumination vein locator 10 is made are readily available and the housing 12, cap 14, and other elements of the trans-illumination vein locator 10 can be inexpensively fabricated from conventional materials and quickly and easily assembled, thus providing a highly effective and safe trans-illumination vein locator 10 at minimal cost.

While the present embodiment described herein represents the best known mode for practicing the present invention, variations in the design are possible without deviating from the spirit of the invention. For example, it may be possible to modify the invention by eliminating features such as the opaque shell 48 for the LEDs or providing different shaped housings.

The description of the present invention has been presented for purposes of illustration and description, but is not intended to be exhaustive or limiting of the invention to the form disclosed. The scope of the present invention is limited only by the scope of the following claims. Many modifications and variations will be apparent to those of ordinary skill in the art. The embodiment described and shown in the figures was chosen and described in order to best explain the principles of the invention, the practical application, and to enable others of ordinary skill in the art to understand the invention for various embodiments with various modifications as are suited to the particular use contemplated.

1. A trans-illuminating vein locator comprising:
a housing comprising a base and a cap;
a lens operatively associated with the cap wherein the cap and lens form a work surface supported by the base and the work surface is configured to support a portion of a patient body for examination; and
an LED operatively disposed within the housing and configured to emit light through the lens to trans-illuminate the portion of the patient body.

2. The trans-illuminating vein locator of claim 1 wherein the housing and lens define a substantially fluid tight interior chamber.

3. The trans-illuminating vein locator of claim 2 further comprising a power switch operatively associated with the enclosure providing a substantially fluid tight barrier between a surface of the switch and the interior chamber.

4. The trans-illuminating vein locator of claim 1 further comprising a power source operatively disposed within the housing.

5. The trans-illuminating vein locator of claim 1 further comprising an attachment clip operatively associated with the enclosure.

6. The trans-illuminating vein locator of claim 1 wherein the LED is configured to emit light having a wavelength substantially between 600 nm and 640 nm.

7. The trans-illuminating vein locator of claim 1 wherein the LED is configured to emit light having a wavelength substantially between 620 nm and 640 nm.

8. The trans-illuminating vein locator of claim 1 wherein the LED is configured to emit light at an angle of dispersion of substantially 30 degrees or less.

9. The trans-illuminating vein locator of claim 1 wherein the LED is configured to emit light at an angle of dispersion of substantially 15 degrees or less.

10. The trans-illuminating vein locator of claim 1 wherein the LED is potted in a substantially opaque material.

11. The trans-illuminating vein locator of claim 1 further comprising a triangular LED array operatively disposed within the housing and configured to emit light through the lens.

12. The trans-illuminating vein locator of claim 11 wherein the LED array is configured to emit light having a wavelength substantially between 600 nm and 640 nm.

13. The trans-illuminating vein locator of claim 11 wherein the LED array is configured to emit light at an angle of dispersion of substantially 30 degrees or less.

14. A method of venous trans-illumination comprising:
providing a trans-illumination device having a work surface and base;
supporting a portion of a patient body on the work surface; and
directing light from a lens associated with the work surface into the portion of the patient body.

15. The method of venous trans-illumination of claim 14 wherein the light is emitted from an LED operatively associated with the trans-illumination device.

16. The method of claim 15 wherein the LED is configured to emit light having a wavelength substantially between 600 nm and 640 nm.

17. The method of claim 15 wherein the LED is configured to emit light at an angle of dispersion of substantially 30 degrees or less.

18. The method of claim 14 wherein the light is emitted from a triangular LED array operatively associated with the trans-illumination device.

19. The method of claim 18 wherein the LED array is configured to emit light having a wavelength substantially between 600 nm and 640 nm.

20. The method of claim 18 wherein the LED array is configured to emit light at an angle of dispersion of substantially 30 degrees or less.
